(19) United States
(12) Patent Application Publication
(10) Pub. No.: US 2006/0091156 A1
(43) Pub. Date: May 4, 2006

(54) Decorative portable skin treatment dispenser

(76) Inventors: Jeffrey Lewis Powers, Plymouth, MI (US); Dennis Willard Davis, Eustis, FL (US); David Paul Thimm, Plymouth, MI (US); James Marvin Stenz, Fenton, MI (US)

Correspondence Address: Dennis W. Davis, 2202 East Washington Avenue, Eustis, FL, 32726, US

(21) Appl. No.: 11/263,478

(22) Filed: Oct. 31, 2005

Related U.S. Application Data
(60) Provisional application No. 60/623,697, filed on Oct. 30, 2004.

(51) Int. Cl. B67D 5/64; B65D 35/38; B65D 25/40; B65D 5/72

(52) U.S. Cl. 222/175; 222/494

(57) ABSTRACT

A flexible, wrist mounted device is disclosed for dispensing skin treatment and skin absorbed pharmaceutical treatments. The device comprises a dispensing volume that is caused to dispense treatment through a diaphragm valve upon simple application of pressure to the device. Various embodiments include devices fabricated from translucent polymeric material and with leak prevention means.

### REFERENCE TO RELATED APPLICATION

This application claims the benefit of U.S. Provisional Application No. 60/623697 filed Oct. 30, 2004.

### BACKGROUND—PRIOR ART

The increase in bacterial immunity to modem antibiotics is problematic and one of the chief vectors of infection is the human hand. Hence, when not in the proximity of a washroom to disinfect one's hands, it would be useful to have a means to accomplish such sanitation. Also, in the midst of daily activities, it can be inconvenient to uncap bottles of disinfecting gels or hand lotions to otherwise treat the hands.

Fortunately, it has been established that ethyl alcohol is a most effective antiseptic for gram-negative pathogens; it is of low viscosity, easily dispensed from a portable container, and does not require the use of a material wipe or cloth because of the speed of evaporation. Further, an adequate dose for sanitizing the hands comprises but a few drops of this antiseptic. To prevent chafing, glycerin can be added to the alcohol without levels of viscosity increase that would be deleterious to the dispensing process.

Various methods of portable disinfectant or lotion dispensers have been disclosed in the prior art. These include body-mounted dispensers, wrist bracelet dispensers, and others. U.S. Pat. No. 6,371,946 discloses a dispensing tube that drips liquid onto the hand. U.S. Pat. No. 6,053,898 discloses a tube-fed finger dispenser. A body-worn dispenser of form factor similar to a pager is disclosed in U.S. Pat. No. 5,927,548.

What has not been demonstrated is a low cost dispenser that is wrist-, arm-, or neck-worn that provides ease of actuation, is leak-proof, and offers fashion appeal.

### SUMMARY OF THE INVENTION

The present invention discloses a wrist- or forearm-mounted device and neck-worn versions for dispensing a small amount of alcohol-based disinfectant hand rub, moisturizer, other skin medicaments, or even pharmaceutical products that would be used for treating various dermatologic or system maladies (the latter being treated through skin absorption of the treatment material). A wristband or other attachment means for affixing the device to arm or wrist is integral to the device. Various locations are feasible including the top, side, or underside of the wrist or forearm. In a preferred embodiment, the device is in the form of a low profile, wrist-mounted dispenser with a membrane valve, much like the tricuspid valve of the human heart, that produces a small amount of dispensed skin treatment when the device is actuated. In another embodiment, a compact version of the dispenser can be worn about the neck on a lanyard or necklace.

To avoid unintended dispensing and leakage of skin treatment material from the device, the membrane valve can be protected by an inflexible ring about its perimeter that is embedded into the polymer construction. Also, replaceable snap-on caps or slide protectors can be used to avoid leakage.

Because only a few drops of alcohol-based disinfectant comprise a dose adequate to achieve sanitation of the hands, the device can dispense hundreds of doses of disinfectant before requiring refill or disposal.

Fashionable versions of the device include those of one-piece construction using brightly colored flexible polymers, translucent versions that permit the display of colored treatment fluid interior to the device, and translucent devices with sparkling material embedded in the translucent polymer.

### OBJECTS AND ADVANTAGES

Several objects and advantages of the present invention are:
(a) Provide a convenient, portable means for dispensing skin treatments;
(b) Provide a cost-effective means for dispensing skin treatments;
(c) Provide an unobtrusive means of dispensing skin treatments;
(d) Provide an easily actuated means of dispensing skin treatments:
(e) Provide an arm- or wrist-mounted means of dispensing skin treatments;
(f) Provide a wrist-mounted disposable means of dispensing skin treatments;
(g) Provide a neck-worn skin treatment dispenser;
(h) Provide a disposable wrist-worn skin treatment dispenser;
(i) Provide an easy-to-manufacture skin treatment dispenser using a diaphragm valve;
(j) Provide a fashionable device that is a desirable apparel accessory.

### BRIEF DESCRIPTION OF THE DRAWINGS

FIG. 1a is a pictorial diagram that depicts the one-piece construction of a wrist-worn embodiment of the device.

FIG. 1b is a cross-sectional diagram of the fluid containing portion of the device of FIG. 1a.

FIG. 2 is a pictorial diagram of a translucent version of the device showing fluid filling the wrist band portion of the device.

FIG. 3a is a pictorial diagram of a wrist-worn version of the device that includes a replaceable cap over the membrane valve that is fully removable from the device.

FIG. 3b is a pictorial diagram of a wrist-worn version of the device that includes a replaceable cap over the membrane valve that is attached the device.

FIG. 4 is a pictorial diagram of a wrist-worn version of the device that includes a protective, inflexible ring surrounding the membrane valve.

FIG. 5 is a pictorial diagram of neck-worn version of the capped membrane valve dispenser.

### DETAILED DESCRIPTION OF THE INVENTION

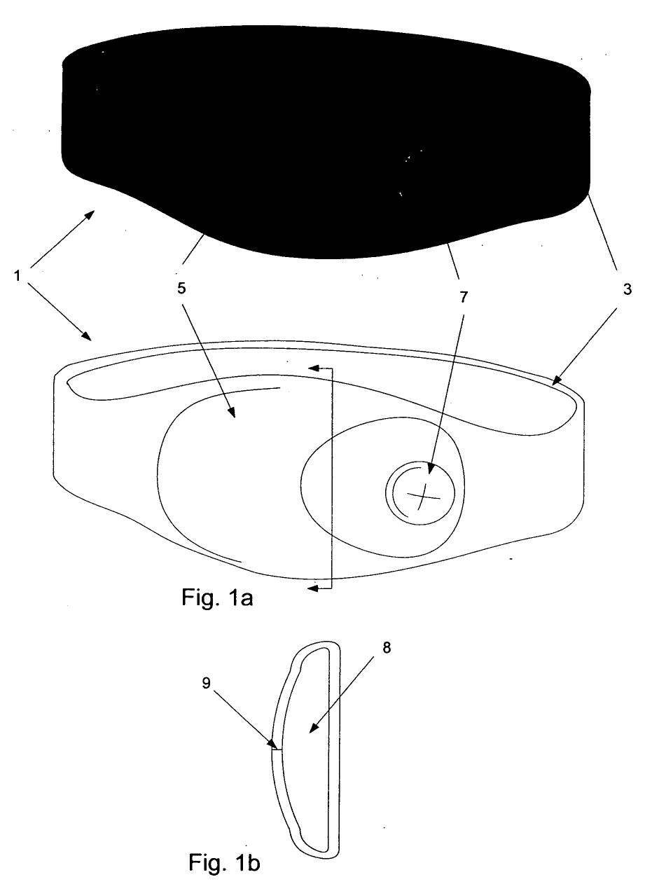

FIG. 1a depicts a wrist-worn device 1 of one-piece construction exhibiting a wrist band portion 3, a fluid-filled portion 5, and a membrane valve 7. This device can be fabricated in a number of ways including injection molding of two pieces that are then fused together to result in the enclosed cavity 5 of the device that can be filled with treatment material.

A cross-sectional view of the device in the region of the fluid-containing cavity 8 is provided in FIG. 1b. As this region of the device is deformed under hand or finger pressure, skin treatment material is caused to be dispensed through the membrane valve 9.

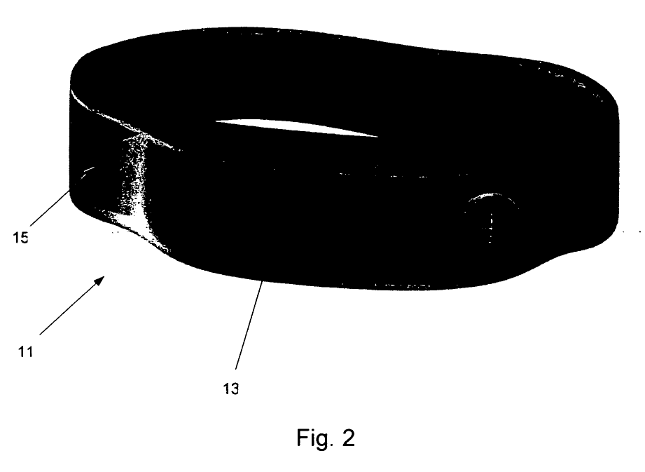

An alternative skin treatment-containing volume is that which includes not only the device volume in the vicinity of the membrane valve, but also some portion of, or the entirety of the wrist band as depicted in FIG. 2. Herein is shown a translucent polymer version of the device 11 that has a cavity 13 extending into the wristband 15. The fashion appeal of such a device lies in the prospect of being able to fill the device including the wrist band volume with skin treatment materials having various colors. The translucent polymer of the device could be pigmented in lieu of, or in addition to coloration of the skin treatment material contained within it. Also, the translucent polymer can have embedded within it, sparkling or other eye-catching materials that would add to the appeal of the device as a fashion accessory.

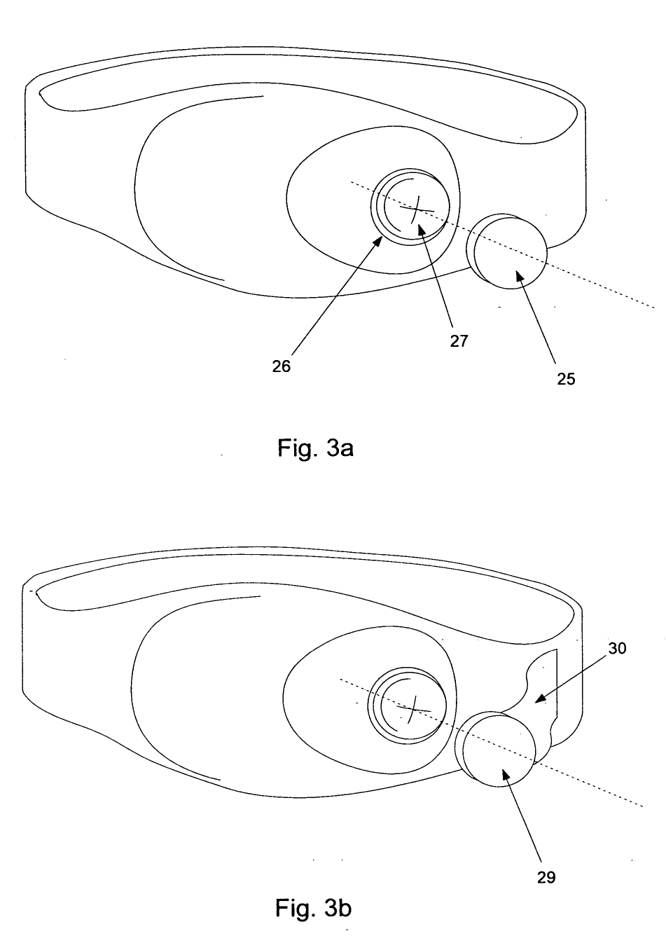

The leakage properties of membrane valves are dependent upon the viscosity of the material to be dispensed, the flexibility of the polymer used in construction of the valve, and the design details of the valve such as valve flap thickness, taper, etc. Some designs may require the addition of a closure over the valve to prevent leakage. FIG. 3a shows a fully detachable cap 25 used for this purpose that snaps onto lip 26 around membrane valve 27 and FIG. 3b shows a cap 29 that remains attached to the device by a tether 30 when removed from enclosing the membrane valve.

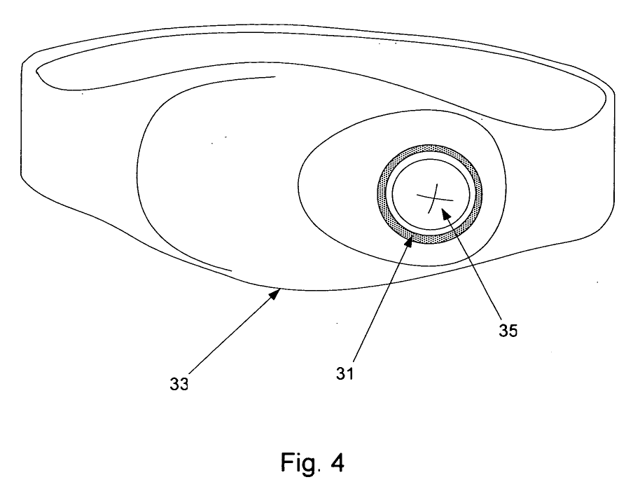

As mentioned, some valve and device designs may not need a cap to prevent leakage. However, some designs might profit from protection from deformation of the device in the vicinity of the valve. As depicted in FIG. 4, this is easily achieved by inclusion of an inflexible “guard” ring 31 that is part of the device 33 and encircles the membrane valve 35.

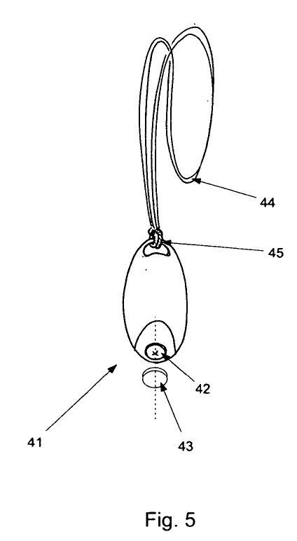

FIG. 5 depicts the membrane valve-based device in a neck-worn embodiment 41 that depicts the valve 42 and cap 43 includes a lanyard 44 and lanyard attachment means 45.

1. A device for dispensing topically-applied skin and pharmaceutical treatments comprising a one piece construction flexible device further comprising:
a) an enclosed dispensing volume;
b) diaphragm valve means; and
c) a wrist attachment portion.

2. A device as recited in claim 1 wherein said device is constructed of translucent polymeric material and said dispensing volume is at least partially contained within said wrist attachment portion.

3. A device as recited in claim 1 wherein said device includes a cap removeably attached to said diaphragm valve means for leak prevention.

4. A device as recited in claim 1 which includes a reinforcing ring around said diaphragm valve means.

5. A device for dispensing topically-applied skin and pharmaceutical treatments comprising a one piece construction flexible device further comprising:
a) an enclosed dispensing volume;
b) diaphragm valve means; and
c) lanyard attachment means for wearing about the neck.
